(19) United States
(12) Patent Application Publication
(10) Pub. No.: US 2014/0278497 A1
(43) Pub. Date: Sep. 18, 2014

(54) Accident Claims Management System

(71) Applicant: Medical Reimbursements of America, LLC, Brentwood, TN (US)

(72) Inventors: Michael Smitherman, Nashville, TN (US); Derek Lawless, Fairview, TN (US); Michael Chance, Nashville, TN (US); Jason Miller, Smyrna, TN (US); Michael Ford, Franklin, TN (US); Lyle Beasley, Nashville, TN (US); Brian Niederhauser, Murfreesboro, TN (US); Chad Powers, Brentwood, TN (US); Beth Grones, Spring Hill, TN (US)

(73) Assignee: Medical Reimbursements of America, LLC, Brentwood, TN (US)

(21) Appl. No.: 14/210,765

(22) Filed: Mar. 14, 2014

Related U.S. Application Data
(60) Provisional application No. 61/787,595, filed on Mar. 15, 2013.

(51) Int. Cl. G06Q 40/08; G06Q 50/22; G06F 19/00

(52) U.S. Cl. CPC G06Q 40/08; G06Q 50/22; G06F 19/328
USPC 705/2

(57) ABSTRACT

A method includes receiving a document indicating information and a charge, identifying a patient in response to a determination that a portion of the information matches a portion of information of a plurality of candidate patients, and determining an eligibility of the patient for a payor.

### CROSS-REFERENCE TO RELATED APPLICATIONS

This application claims priority to U.S. Provisional Application No. 61/787,595, filed Mar. 15, 2013, the contents of which are incorporated herein by reference in their entirety.

### BACKGROUND

1. Technical Field

The disclosure relates generally to the field of accident claims management and workers' compensation and, more particularly, to healthcare claims processing involving multiple parties that are responsible for payment.

2. Background Art

After being injured in an accident, whether a workers' compensation, premises liability or automobile accident, a patient seeks treatment by a healthcare provider (e.g., a hospital or a physician). Currently, a process used by the provider to obtain payment after treating the patient is entirely manual. The process is almost exclusively paper- and telephone-based, involving, e.g., telephone calls, letter writing, paper-billing, and payments by check.

Even in a simple two-party accident, there are many parties that can bear responsibility for payment, such as: (i) the injured party; (ii) the injuring party; (iii) the injured party's no-fault insurance; (iv) the injuring party's liability insurance; (v) the injured party's health insurance; and (vi) Medicare or Medicaid.

Typically, when an injured person presents to a provider after an accident, she provides her health insurance information to the provider. Sometimes, the injured person's health insurance pays the provider for services performed. In other instances, the healthcare provider identifies another payor, such as the injured person's no-fault auto insurance company, who pays the provider. The health insurance and other payor may have recourse against (i) each other, (ii) the injuring person, and/or (iii) the injuring person's liability insurance (e.g., automobile liability insurance or workers' compensation insurance). If statutorily or contractually allowed, the provider may also file a lien against a pending liability action between the injured person and the injuring person to secure payment in the event of a collectible judgment against the injuring person.

Other payors who may be responsible to a provider for an accident claim (automobile or other personal injury) include, but are not limited to, commercial health insurance (e.g., Aetna, Blue Cross, etc.) and government insurance (e.g., Medicare, Medicaid, TRICARE, CHAMPVA, etc.). There are two types of property and casualty insurance: (1) no-fault insurance property and casualty insurance, either called MedPay (Medical Payments Benefits) or PIP (Personal Injury Protection); and (2) third-party liability insurance. In addition, payors may include attorneys representing the various parties.

The parties potentially responsible to a provider for a workers' compensation claim are slightly different. These parties can include, but are not limited to, (1) the employee, (2) the employer, (3) a third party administrator, if the employer is self-insured, (4) an independent workers' compensation carrier, and (5) a third-party carrier. Each party may also have lawyers involved. Health insurance may also be responsible if the workers' compensation claim is deemed non-compensable.

Further, in a workers' compensation claim, the patient should not be billed: only the workers' compensation carrier should be billed. State-by-state rules apply to allowable payments, as well; a provider may only be paid as set in a state's established fee schedule.

Each payor has specific requirements that should be fulfilled before the payor will pay an accident claim. If a payor makes a payment without the applicable rules being met, the payor can take that money back from the provider or another insurance payor by subrogation or recoupment.

### BRIEF SUMMARY

Advances in this industry have been stifled because of the complexity of determining responsibility for healthcare claims that result from accidents. Currently, there is no system to administer financial responsibility for workers' compensation and automobile insurance claims, as between the multiple responsible parties, each of whom seeks to maximize the responsibility of the other parties. Additionally, if a provider treats an injured person, but cannot identify or recover from any of the responsible parties, the provider does not get paid.

What is needed is a system and method that enables participants to communicate information with each other to settle an accident claim without time-intensive letter-writing campaigns, paper billing, and telephone calls. Additionally, the system and method should enable an administrator to pursue a claim from submission through the various participants and approval processes in the right order, by the right payor, and at the right times.

In some embodiments, an Internet-based (e.g., web-based) software accident claims responsibility management system, computer program and method identify and resolve payment responsibility between parties who are financially responsible for healthcare expenses arising from an accident. The system can give a provider the ability to submit claims to the system and receive electronic payments from a plurality of payors.

One current problem with payment is that hospitals receive multiple checks from multiple payors and have trouble posting them to the correct accounts. The accident claim management system resolves this because all payments can be remitted into or tracked by the accident claim management system. In some embodiments, the accident claim management will allow payments to be remitted into and tracked by the accident claim management system.

The system also automates the process for filing liens against accident lawsuits in accordance with state laws to secure the provider's interest in collected judgments.

The system can be used by providers, employers, and employees for workers' compensation claims and by providers, injured persons, injuring persons, and insurance companies for automobile accident claims, as well as by attorneys representing any of the interested parties.

In one embodiment the accident claims management method involves receiving a document indicating information and a charge; identifying a patient in response to a determination that a portion of the information matches a portion of information of a plurality of candidate patients; and determining an eligibility of the patient for a payor.

In another embodiment, the received information includes a first name or a last name of the patient, and the determination determines that a predetermined number of letters of the first name or the last name matches a predetermined number of letters of a first name or a last name of one of the plurality of candidate patients. In another embodiment the method involves determining if a predetermined number of letters of a first name or a last name of the patient matches a predetermined number of letters of a first name or a last name of one of the plurality of candidate patients and if a date associated with the patient matches a date associated with the one of the plurality of candidate patients. In yet another embodiment, the method involves associating the information with an event based on a weighted determination of a medical record number, a provider name, a patient account number, and dates of service of one of the plurality of candidate patients. In another embodiment, the method involves investigating the payor based on the information. In another embodiment, the method involves billing at least a portion of the charge to the payor. In another embodiment, the method involves generating a notification of a remaining balance in response to a determination that a last payor of a determined order has been reached.

In one embodiment, the processor circuit receives a document indicating information and a charge, to identify a patient in response to a determination that a portion of the information matches a portion of information of a plurality of candidate patients, and to determine an eligibility of the patient for a payor.

In another embodiment, the processor circuit receives information including a first name or a last name of the patient, and the determination determines that a predetermined number of letters of the first name or the last name matches a predetermined number of letters of a first name or a last name of one of the plurality of candidate patients. In another embodiment, the processor circuit determines if a predetermined number of letters of a first name or a last name of the patient matches a predetermined number of letters of a first name or a last name of one of the plurality of candidate patients and if a date associated with the patient matches a date associated with the one of the plurality of candidate patients. In another embodiment, the processor circuit associates the information with an event based on a weighted determination of a medical record number, a provider name, a patient account number, and dates of service of one of the plurality of candidate patients. In another embodiment, the processor circuit investigates the payor based on the information. In another embodiment, the processor circuit bills at least a portion of the charge to the payor. In another embodiment, the processor circuit generates a notification of a remaining balance in response to a determination that a last payor of a determined order has been reached.

In one embodiment, a non-transitory, computer-readable medium encoded with computer-executable instructions that, when executed by a processing unit, cause the processing unit to perform an accident claims management method, the method involving: receiving a document indicating information and a charge; identifying a patient in response to a determination that a portion of the information matches a portion of information of a plurality of candidate patients; and determining an eligibility of the patient for a payor.

In another embodiment, the information includes a first name or a last name of the patient, and the determination determines that a predetermined number of letters of the first name or the last name matches a predetermined number of letters of a first name or a last name of one of the plurality of candidate patients. In yet another embodiment, the method involves determining if a predetermined number of letters of a first name or a last name of the patient matches a predetermined number of letters of a first name or a last name of one of the plurality of candidate patients and if a date associated with the patient matches a date associated with the one of the plurality of candidate patients. In yet another embodiment, the method involves associating the information with an event based on a weighted determination of a medical record number, a provider name, a patient account number, and dates of service of one of the plurality of candidate patients. In yet another embodiment, the method involves investigating the payor based on the information; and billing at least a portion of the charge to the payor. In yet another embodiment, the method involves generating a notification of a remaining balance in response to a determination that a last payor of a determined order has been reached.

### BRIEF DESCRIPTION OF THE SEVERAL VIEWS OF THE DRAWINGS

The attached diagrams provide a detailed summary and a description of several embodiments, where

FIGS. 1A-1C are diagrams showing parties and information sources potentially involved in resolution of an accident claim;

FIG. 2 is a flow chart illustrating one embodiment of an algorithm for accident claims management using an accident claims management system;

FIGS. 3A-3B show a flow chart illustrating one embodiment of an algorithm for associating a document with a patient using an accident claims management system;

FIG. 4 is a flow chart illustrating one embodiment of an algorithm for associating a document with an event;

FIG. 5 is a flow chart illustrating one embodiment of an algorithm for investigating a payor based on a document;

FIG. 6 is a flow chart illustrating one embodiment of an algorithm for generating a bill; and

FIG. 7 is a block diagram showing components of one embodiment of a computer system for implementing an accident claims management system.

### DETAILED DESCRIPTION

In one embodiment, an accident claim system provides providers with an automated remittance file, typically known as an 835 in the industry. The system enables information associated with each payment (e.g., a remittance file) to be uploaded into a provider's information systems, which has traditionally been challenging because of the large number of participants and claims.

FIG. 1A is a block diagram showing potential sources of payment and information in one embodiment of an accident claims management system. These sources include (1) healthcare providers, (2) property and casualty payors, (3) commercial health payors, (4) Medicare and Medicaid, (5) attorneys, (6) patients, (7) employers, (8) workers' compensation carriers, (9) third-party administrators, and (10) subrogation entities.

Providers can place documentation into the accident claim system, such as medical records, invoices, and discharge summaries. Providers also can obtain information, such as claim status, from the system, as such information pertains to the providers' claims.

Property and casualty payors (e.g., no-fault insurers and third-party liability insurers) can access the system to provide and obtain information. Examples of such provided information are claim status and payment information. Such obtained information relates to subrogation and the status of third-party liability claims.

Commercial health payors can access the system to provide and obtain information, such as completed subrogation forms, payment information, and explanation of benefits (EOB). The commercial health payors can also receive, e.g., a prompt to pay a claim.

Government health payors (e.g., Medicare and Medicaid) can access the system to provide and obtain information. Some examples of such information are updates for complying with Medicare Secondary Payer regulations, and a notification of potential primary payors.

Attorneys (e.g., plaintiffs' attorneys or defense attorneys) can access the system to provide and obtain information regarding, e.g., pending claims and liability actions. Additionally, attorneys can access the system to obtain information about subrogation claims or payments.

Patients can access the system to provide, e.g., accident information, as well as to obtain claim status information.

Employers of the patients in workers' compensation cases or in Employee Retirement Income Security Act (ERISA) actions can access the system to obtain, e.g., status information on a claim, to provide status information, and to provide documentation. For example, an employer might provide the first report of injury to open a workers' compensation claim.

Workers' compensation payors can access the system to, e.g., submit documentation of payment or request documents, such as medical records or invoices.

Third-party administrators in one example can access the system to obtain payment information, such as status updates on contested claims, and to provide information concerning payments and EOBs.

Subrogation entities can access the system to receive or provide information on subrogation claims and to determine primary payors to avoid paying a claim out of order. A subrogation entity can use the system to confirm whether there is a liability claim and/or a no-fault claim pending so that a payor does not overpay its portion of responsibility.

FIG. 1B is a block diagram showing potential payors, such as types of insurance. These payors include, but are not limited to, (1) no-fault insurance policies, (2) commercial health insurance policies, (3) liability insurance policies, whether automobile or workers' compensation, (4) government health insurance policies, (5) workers' compensation policies, (6) contested liability claims and cases, (7) other health insurance policies, and (8) the patient. The system tracks the patient's guarantor or guarantors, attorney, as well as any existing or previous insurance policies or coverages.

FIG. 1C is a block diagram showing potential sources of information and documents received by the system. These sources include, but are not limited to, (1) medical documents, (2) police reports, (3) historical accident claims, particularly with regard to fraud prevention and control, (4) demographic information, including a patient's ability to pay, (5) personal injury lawsuits, including past lawsuits, (6) consumer credit reports, (7) fraud prevention information, and (8) pre-existing medical condition data. Examples of medical documents include medical records, AOBs (assignments of benefits), and EOBs to process that information. The demographic information includes basic patient information, such as first name, last name, address, telephone number, date of birth, patient contact information, and claim data. The demographics information can also include a PAR (patient account record) record set.

FIG. 2 illustrates a flowchart providing an overview of one algorithm for accident claims management that can be implemented by the system. As the system processes a claim, the system can take incomplete and unstructured information included in a document and refine and match the information with other information in the system to generate a bill. For example, the system can receive a string of characters such as “State Farm Property Casualty Payor, Inc.” and recognize “State Farm,” and match State Farm as a recognized payor in the system with specific rules on when, how, and who to bill.

The operations begin at S200 and proceed to S210 in which the system receives a document regarding an accident, e.g., an automobile accident claim or a workers' compensation claim. The document can be received in an electronic format (e.g., text files and binary data) or as a physical paper document. The text files can be delimited files (e.g., comma-delimited, tab-delimited, colon-delimited, etc.), multi-record files, Extensible Markup Language (XML) files, and electronic data interchange (EDI) files. The text files can also be in a proprietary format agreed upon with a given provider or vendor. The binary files can be binary images of documents or screenshots, in formats such as Tagged Image File Format (TIFF), Portable Document Format (PDF), Open XML Paper Specification (XPS), and Portable Network Graphics (PNG) formats. When information is received electronically, the information can be in a standard healthcare EDI format, such as 837 Institutional or 837 Professional. In some implementations, it is possible to upload images of patient documentation, such as scans of insurance cards, itemized statements, AOBs, EOBs, implant invoices, police reports, and claims.

When paper documents are received, the paper can be scanned into an electronic format, such as one of the formats described previously, and processed as electronic data. The paper can optionally undergo optical character recognition (OCR) as part of the scanning Of course, the system is not limited to such an implementation. In one example, a human can review the paper and enter the information into the system using an input device, such as by typing on a keyboard, selecting options from a pull-down menu with a mouse, etc.

The document can be received from a provider as a pushed file or by pulling the document from the provider's systems. The document can be received via File Transfer Protocol (FTP), Hypertext Transfer Protocol (HTTP), electronic mail, or any other suitable transmission format. The document can also be received using a portal or a publicly available GlobalSCAPE EFT Server (virtualized). Encryption technologies are implemented in preferred embodiments.

Claims can be identified in the document by receiving codes (e.g., a series of letters and numbers) from a provider's system. The claims can include information that identifies, e.g., a patient and a charge, for example, a dollar amount due, as well as other information. The information identifying a patient can be, e.g., a first and last name, a Social Security number, a patient control number, a medical record number, or any other information discussed later. Of course, other information can be included in the document as well, such as an identification of a payor, dates of service, or any other information described later.

The documents can include patient account records (PAR) and HIPAA EDI 837 Institutional and Professional claims. PAR data arrives in various previously agreed-upon formats from providers and vendors. HIPAA EDI data is retrieved from a clearinghouse and is initially parsed into a format that allows the system to store each discrete data element from the claim. This process also handles the de-batching of the claim file into individual claims, the resolution of the provider from its corresponding National Provider Identifier (NPI) into the system's internal representation of that provider, and a de-duplication process to ensure duplicate claims do not exist in the system.

Upon receiving a document in S210, the system can optionally transmit an acknowledgement back to a submitter of the document. If the document is not recognized by the system, the system can reject it. In one implementation, the system uses an output device, such as a display, to prompt a human to send the document back to the submitter. In an alternative embodiment, the device transmits the document over a network interface.

In S220, the system attempts to associate the document with an existing patient. In one implementation, each patient is assigned a unique number in the system, even if that patient goes to multiple hospitals, has been in multiple accidents, or has multiple accounts or claims with providers. The system tries to create only one patient record and to avoid multiple patient records for a single patient. The association of S220 is discussed in more detail later.

In S230, the system determines whether the received document pertains to an existing event (e.g., an accident) in the system. If the received document pertains to an existing event, the system proceeds to S260. If the received data does not pertain to an existing event, the system advances to S240.

In S240, a new event is created. The system then proceeds to S250, in which the system determines the type of the event (e.g., automobile accident or workers' compensation accident), and then proceeds to S260.

The system matches the document or information with an event in S260. This data association is discussed in more detail later.

The system then conducts an investigation to determine the payors responsible for the event in S270. This investigation is discussed in more detail later.

The system then generates a bill for the payor in S280. This generation is discussed later in more detail.

The accident claims management operations conclude at S290.

FIGS. 3A-3B show a flow chart illustrating one embodiment of an algorithm for associating a document with a patient using an accident claims management system.

The operations of FIG. 3A begin at S300 and proceed to S305. The operations of S305-S370 generally compare information of a patient in the document received in S210 to information of candidate patients in the system. In particular, S305-S370 consider the outcome of pairs of comparisons. In one implementation, the information of the received patient is compared against every patient in the system, though some implementations make a comparison against fewer than every patient in the system by filtering out some patients. Also, in some implementations, more or fewer determinations are made than those identified in S305-S370, and those determinations that are performed can be in a different order, be performed conditionally, or be performed in parallel. In addition, fuzzy logic can be implemented to address minor inconsistencies (e.g., those likely originating from transcription or typographical errors), such as described below.

In S305, the system determines whether a predetermined number of initial letters of the received patient's last name matches a predetermined number of letters of a candidate patient's last name. In one embodiment, both predetermined numbers are 4, but other implementations are possible. For example, the system can implement fuzzy logic to match “McNa” to “MacN” and “Da F” to “Daf?” (e.g., “Dafr”). In addition, in S305, it is determined whether the date of birth of the received patient matches the date of birth of the candidate patient.

In S310, the system considers whether a predetermined number of initial letters of the received patient's last name matches a predetermined number of letters of a candidate patient's last name. Again, both predetermined numbers can be 4, but other implementations are possible. In addition, in S310, the system determines whether a predetermined number of ending digits of the Social Security number of the received patient matches the same predetermined number of ending digits of the Social Security number of the candidate patient. In one embodiment, these predetermined numbers can be 4, but more or fewer digits can be considered.

In S315, the system considers whether a predetermined number of initial letters of the received patient's last name matches a predetermined number of initial letters of a candidate patient's last name. As before, both predetermined numbers can be 4, but other implementations are possible. In addition, in S315, the system determines whether a date of an incident of the received patient matches a date of an incident of the candidate patient. This date of incident generally refers to a date of an accident.

In S320, the system considers whether a predetermined number of initial letters of the received patient's last name matches a predetermined number of initial letters of a candidate patient's last name. Again, both predetermined numbers can be 4, but other implementations are possible. In addition, in S320, the system determines whether the dates of service of the received patient match the dates of service of the candidate patient.

In S325, the system determines whether a predetermined number of initial letters of the received patient's first name matches a predetermined number of initial letters of a candidate patient's first name. In one embodiment, both predetermined numbers are 4, but other implementations are possible. As discussed previously with regard to the last names, fuzzy logic can be implemented. In addition, in S325, the system considers whether the date of birth of the received patient matches the date of birth of the candidate patient.

In S330, the system considers whether a predetermined number of initial letters of the received patient's first name matches a predetermined number of initial letters of a candidate patient's first name. Again, both predetermined numbers can be 4, but other implementations are possible. In addition, in S330, the system considers whether a predetermined number of the ending digits of the Social Security number of the received patient matches the same predetermined number of the ending digits of the Social Security number of the candidate patient. In one embodiment, these predetermined numbers can be 4, but more or fewer digits can be considered.

In S335, the system considers whether a predetermined number of initial letters of the received patient's first name matches a predetermined number of initial letters of a candidate patient's first name. As before, both predetermined numbers can be 4, but other implementations are possible. In addition, in S335, the system considers whether a date of an incident of the received patient matches a date of an incident of the candidate patient.

In S340, the system considers whether a predetermined number of initial letters of the received patient's first name matches a predetermined number of initial letters of a candidate patient's first name. Again, both predetermined numbers can be 4, but other implementations are possible. In addition, in S340, the system considers whether the dates of service of the received patient match the dates of service of the candidate patient.

In S345, the system considers whether the 9-digit Social Security number of the received patient matches the 9-digit Social Security number of the candidate patient.

In S350, the system determines whether the medical record number of the received patient matches the medical record number of the candidate patient.

In S355, the system determines whether the patient account number or the patient control number of the received patient matches the patient account number or the patient control number of the candidate patient.

In S360, the system determines whether the claim number of the received patient matches the claim number of the candidate patient.

In S365, the system determines whether the 10-digit telephone number of the received patient matches the 10-digit telephone number of the candidate patient.

In S370, the system determines whether the last 7 digits of the telephone number of the received patient matches the last 7 digits of the telephone number of the candidate patient.

In S365 and S370, the system tracks phone numbers that have been received in the past and which ones are valid, invalid, inactive, and on do-not-call lists.

Turning to FIG. 3B, in S375, the system determines how many matches were found between the received patient and the candidate patient, e.g., in S305-S370. If no matches were found in S375, the system advances to S380, where a new patient record is created based on the information of the received patient. In another embodiment, the system sends that information to an exception queue for later review. When the system receives information in the exception queue, the system can call that provider or patient to resolve the problem or prompt a human to call that provider or patient.

If exactly one match was found in S375, the system proceeds to S385, in which the system associates the received patient with the matching candidate patient. The system can update information of the candidate patient based on the information of the received patient.

If more than one match was found in S375, the system advances to S390, in which the received patient is identified as possibly associated with the matching candidate patients. In this case, the system can use an output device to list the matching candidates and can receive an input from an input device identifying one of the candidate patients matching the received patient. The system can then update information of the candidate patient based on the information of the received patient. In one embodiment, a user accesses the system by an Internet (e.g., web) application or, for example, a cellular phone application, and is presented a list of candidate patients. In one embodiment, the system indicates to the user whether a match is a full match or a partial match, or provides another indicator to give the user a likelihood of a match based on matching a name, a date of birth, a medical record, a Social Security number, etc.

At S395, the system then concludes the operations for associating the document with a patient.

Although the system tries to match each document with a patient, the system can also substitute another matching of the information with a patient. In addition, the system can hold the information for a manual review of the match. Further, an optional control can be triggered based on thresholds. When information or a document meets a threshold, such as a client, a state, an accident type, a zip code, or a dollar amount, the system can implement the manual review.

FIG. 4 is a flow chart illustrating one embodiment of an algorithm for associating information in a document with an event. The system tracks information at the event level about what happened in the accident and when. Examples of this information include whether the employer has been notified that an accident occurred, whether the patient has been cited for the accident or was at fault, and, in the case of an automobile accident, other drivers involved.

The system can check the provider, document type, and claim balance, or any other information to determine whether the document is relevant and to prevent large batches of erroneous information from negatively impacting system and process efficiency. Information that cannot be matched is redirected to an exception queue where the information is reviewed and either reintroduced into the workflow or returned to the provider.

The operations begin at S400 and proceed to S405. At S405, the system determines the type of the document. If the system determines the document is a claim, the system advances to S410. If the system determines the document is a patient account record, the system advances to S425. Alternatively, if the system determines the document is any other type of document (e.g., a police report), the system advances to S440.

At S410, the system determines whether information in the document matches an existing claim patient control number and its dates of service. If the information matches the existing claim patient control number and the dates of service, the system advances to S415. If the information does not match both the existing claim patient control number, the system advances to S420.

At S415, the system updates the claim based on other information in the document and proceeds to S445.

At S420, the system determines whether the information matches an existing account based on a medical record number, a provider, a patient account number, and the dates of service, each of the existing account. If the system determines a match is not found, the system advances to S430. If the system determines a match is found, the system advances to S435.

As different matches can be found in S420 (e.g., the medical record number and the provider match, but the dates of service are different), the system can use a weighting algorithm to determine whether a sufficient amount of information matches. Needless to say, if all of the information matches, the system determines the information matches, and if none of the information matches, the system determines the information does not match.

At S425, the system determines whether the information in the document matches a patient account number and the dates of service for an account. If the information does not match both the patient account number and the dates of service, the system advances to S430. If the information matches the patient account number and the dates of service, the system advances to S435.

At S430, the system creates a new account based on the information. The system then advances to S445.

At S435, the system updates the account based on other information in the document and proceeds to S445.

At S440, the system handles the document as general correspondence. In one embodiment, this handling includes presentation of the document or its information on a display, a review by a human, and a receipt of an input by an input device indicating how the document should be handled. Of course, more sophisticated processes can also be performed. Upon completion of the general correspondence handling, the system advances to S445.

At S445, the operations for associating the information in the document with an event conclude.

FIG. 5 is a flow chart illustrating one embodiment of an algorithm for investigating a payor. There are three primary types of rules that can be considered in investigating payors. First are provider profile rules based on the hospital/provider. For instance, the system can return or reject a workers' compensation claim if the claim does not have a workers' compensation carrier. Also, the system will implement certain rules on phone calls and when to return them.

Second are the payor profile rules. These are broken down into categories, such as property and casualty, health insurance, workers' compensation, premises, and attorney payors. The system can have a separate set of rules for each category of payors and for each individual payor. The system can capture payor preferences, including, without limitation, preferences for an address, phone numbers, and fax numbers.

Third, the system can implement state and county rules particular to resolving claims in those jurisdictions. For instance, those rules can pertain to the process for resolving liens in a particular state and county. System profiles can be set for managing rules for hospital liens in a particular state. The system can also set rules for federal regulations (e.g., Medicare Secondary Payer regulations) that dictate how the system handles accident claims for a Medicare beneficiary.

The system begins at S500 and proceeds to S510, in which the system determines whether a payor identified in the document matches an existing payor in the system. If the system determines the payor does not match an existing payor in the system, the system advances to S520. If the system determines the payor does match an existing payor, the system proceeds to S550.

In one embodiment, once a payor has been identified, a human is presented a list of previously verified payors to choose from. If the human does not find a match from the existing payor database, the human can add new payors to the system to be verified, and the system proceeds to S520. The system attempts to maintain one instance of the payor in the system so that the system can consistently apply rules, consistently track activity with that payor, as well as facilitate some of the back-end processing, such as sending electronic data, prompting phone calls, or sending physical documents. Optionally, the system can restrict the ability to add new payors to the system.

At S520, the payor is researched. In one embodiment, the system conducts an Internet search for a webpage associated with the payor, using an Internet presence as an indicator of legitimacy. In another embodiment, the system prompts a human, using an output device, to call a telephone number associated with the payor. This telephone can be acquired from the information within the document or can be recognized from, e.g., the aforementioned webpage. Of course, other ways of researching a payor can be conducted, such as by sending or receiving a facsimile or a letter.

At S530, the system determines whether the payor is valid, based on the research performed at S520. In one embodiment, the system displays pertinent information (e.g., a telephone or facsimile number, a mailing or electronic mail address, a webpage, a bank account number, or a lack of any such information) using an output device and awaits an input indicating whether the payor is valid or not. In another embodiment, the system makes the determination without displaying the pertinent information, such as by a weighting algorithm considering the legitimacy of a payor (e.g., based on whether a call to the telephone number is answered or not, whether the mailing address maps to a deliverable address or not, whether the bank account number corresponds to an actual bank account number or is, e.g., frozen, etc.). Previous association can also inform the validity determination. For instance, for a workers' compensation claim, the system can identify the workers' compensation carrier that represents the employer's responsibility. The system can check to see if the system has previously matched that employer with an insurance carrier. If the system determines the payor is valid, the system advances to S540 to add the payor to the system. If the system determines the payor is not valid, the system proceeds to S570.

At S540, the payor is added to, e.g., a dropdown menu in the accident claim system as a new payor. The new payor's rules are defined such that when that payor is to be billed, rules for a clean claim submission are available and accounted for by the system. Then, the system advances to S550.

At S550, the system determines whether the patient is eligible for payment by the payor. In one example, the system presents information using an output device and receives an input indicating whether or not the patient is eligible. For example, the presented information might indicate a telephone number of the payor, and the telephone number is dialed to ask about coverage. In one example, the system dials the telephone number itself or electronically contacts the payor, such as by a portal, with information to determine whether coverage is available for the patient. If the patient is eligible for the payor, the system advances to S560. The system will prompt the payor to verify that that patient does have active, valid insurance coverage for the event in question, and that there is, in fact, a claim open for that individual. If the patient is not eligible for the payor, the system proceeds to S570.

At S560, the system applies the payor to the claims based on the dates of service. The system then advances to S570. There are regulations governing automobile insurance and workers' compensation claims, such as, but not limited to, Medicare Secondary payor rules. For example, under the Medicare rules, a claimant should exhaust MedPay or PIP and all third-party liability payors prior to billing Medicare. However, Medicare also has a condition that allows Medicare to be billed if the third-party liability claim is not going to pay within 120 days. In addition, certain information should be provided at different times based on a given state's regulatory requirements for the particular claim. Workers' compensation has a specific state fee schedule in each state that a workers' compensation carrier should pay. The system can also track benefits under policies for health or property and casualty so that it anticipates the amount due on each claim. The system can prompt a human, a provider, or a payor for these documents. Upon receipt of these documents, the system can return to S210. As more information is entered into the system, the system can match more data points (e.g., a particular employer matches a particular workers' compensation carrier).

At S570, the operations for investigating a payor conclude. If the system lacks sufficient information (e.g., accident details), the system can contact the patient to determine additional sources of payment (e.g., in the case of a workers' compensation carrier, the name of the employer, or, in the case of a property and casualty insurance carrier, the name of the carrier). In one embodiment, the system integrates with a phone system and presents information about a party to be called and the information that should be retrieved, and dials and tracks or records the conversation. In one implementation, the system commits the information to the system only after a note about the call is entered in the system. The calling protocols can be set by the profile rules that dictate how many times to contact the patient or whether sufficient information has been received. For example, if the system sees a patient has been called for 45 days without an answer, then the system can return the claim to the provider.

FIG. 6 is a flow chart illustrating one embodiment of an algorithm for generating a bill.

FIG. 6 begins at S600 and proceeds to S605. In S605, the system generates a billing order based on the identified payors and the payment rules for each payor. Once the system determines the order of billing in S605, the system can inform the user using a visual or audible indicator of a completion thereof.

In S610, the system identifies a first payor that can be billed. For example, in a particular state, MedPay should be billed first, so the system bills MedPay and submits that bill either by paper through a portal, or otherwise electronically, or faxes it. The system can prompt a follow-up, if the bill is not paid within a set period of time.

Then, in S615, the system transmits a bill to the payor and proceeds to S620.

In S620, the system determines whether a notification of the payment from the payor has come in from, e.g., the provider to be posted to the applicable claims in the system. In one example, the system can receive transaction files from the provider indicating a payment has been received from the payor; once the transaction file comes in, the payment is applied to the claim. Alternatively, a human can verify payment in person and provide an update to the system. In another embodiment in which the notification is the payment itself, the system can remit payment to the provider along with an electronic statement that reflects the payment from the payor for a specific account and instruct the provider how to post those payments to the account. In addition, the system can prompt a user to follow up to see what funds have been received by a provider from each payor. If the payment is received, the system advances to S625. The payment is not received, the system advances to S640.

In S625, the system determines if there is a remaining balance. If there is a remaining balance, the system proceeds to S630. If there is not a remaining balance, the system proceeds to S650.

In S630, the system determines whether the system has reached the last payor of the determined order or not. If the system has reached the last payor, the system advances to S635. If the system has not reached the last payor, the system advances to S645.

In S635, the system uses an output device to present a notification that the payors have been exhausted although a balance remains. This notification can be forwarded to, e.g., a provider to alert the provider that the remaining balance should be written off. The system then proceeds to S650.

In S640, the system determines whether a predetermined period of time has elapsed without receiving a payment. For example, the system can wait, e.g., a certain number of months, before submitting a bill to a next payor (e.g., Medicare), while the system waits to see if payment is received from another source (for example, if a lawsuit will be settled).

If the predetermined period of time has elapsed, the system advances to S645. If the predetermined period of time has not yet elapsed, the system returns to S620.

At S645, the system advances to the next payor in the determined order.

At S650, the operations for generating a bill conclude.

In one embodiment, the system can tell the provider that (1) the system has collected payment or achieved the right reduction request or payment amount from a liability action, or (2) the recovery depends on the state the action is in and that state's respective hospital lien laws. For example, in Tennessee, a third of any settlement goes to any medical provider who has a perfected lien. The system can account for medical bills associated with a case, liens associated with a case, secured debt, and a settlement amount.

In one embodiment, the system can provide a web-based application that entities can access based on the entities' relationship to the patient. For instance, a claims representative from an insurance company, e.g., Gallagher Bassett, can access those patients that have outstanding claims billed to Gallagher Bassett. In some implementations, the system allows multiple layers of access across a diverse group of patients based on the payors and providers associated with the claims for that patient. Conversely, a provider can have access to all patients in the system with claims associated with that provider.

At the no-fault insurance level, the system has a web interface in some embodiments so that interviews can happen in the emergency room. A device accessing the web interface can capture that information, and the system can collect information on paper and put it into the system. If a particular carrier requires a signature, as opposed to a verbal authorization, the device can trigger an actual authorization to be signed to open up an accident claim. If it turns out that that carrier requires specific documentation (e.g., an AOB), the device can gather that information.

FIG. 7 shows an exemplary computing device of the system that can be used as any of the devices described previously. The device can include a processor 700, random access memory (RAM) 710, read-only memory (ROM) 720, a hard drive 730, input device(s) 740, external memory 750, a network interface 760, and output device(s) 770 connected by a bus 780. In some embodiments, fewer or additional components are present.

The processor 700 is any processing circuit (i.e., at least partially implemented in hardware) that can be configured to execute the algorithms set forth in this description. The processor 700 can be, e.g., programmable array logic (PAL), generic array logic (GAL), a CPU (e.g., an Intel i7 processor or an AMD AM1 processor), a digital signal processor (DSP), or any other processor. The processor 700 can be a 16-bit processor, a 32-bit processor, a 64-bit processor, or any other suitable processor. The processor 700 can include one or more processing cores. Such a processor 700 is an example of a processing means.

The RAM 710 is a memory commonly used as a work area for an executing program. The ROM 720 is a memory commonly used for storing programs executed at boot-up. The hard drive 730 is a drive commonly used for storing applications and other programs not necessarily required at boot-up. The hard drive 730 can be optical, magnetic, or a solid state drive, as well as implemented in any other appropriate technology. The RAM 710, ROM 720, hard drive 730, and the external memory 750 are examples of a storing means.

The input device(s) 740 can include any kind of known keyboard, such as QWERTY, Dvorak, or a numeric keypad. The input device(s) 740 can include a mouse that uses a ball or an infrared light. The input device(s) 740 can also include a trackball, a scanner, or a joystick.

The external memory 750 can be, e.g., a floppy disk drive, a flash drive, or an optical disc drive. A CD/DVD drive is an example of an optical disc drive. The optical disc drive can accept Blu-ray discs in one embodiment. Of course, the optical disc drive can be supplemented with or replaced by an opto-magnetic disc drive, in one example.

The network interface 760 connects the computer to another computer over a network, such as the Internet, a local area network (LAN), or a wide area network (WAN). The network interface 760 can be a modem or an Ethernet card, in some embodiments. The network interface 760 can transmit and/or receive wired or wireless communications. The network interface 760 can also use Bluetooth technologies in some examples. The network interface 760 is an example of a networking means.

The output device(s) 770 can include speakers that output sounds generated by the system, such as a notification generally or specifically a beep or a voice. The output device(s) can include a printer or a display. The display can display records from the database or the notifications generated by the system. In some embodiments, the display is a touch screen and can also be an input device.

In some embodiments of the present disclosure, the algorithms are executed by the processor 700. These algorithms can be stored on a non-transitory medium, such as in the cache in the processor 700, RAM 710, ROM 720, hard drive 730, or a medium in external memory 750. The algorithms can also be stored in a transitory medium, such as a propagating wave or signal received by the network interface. A transitory medium can also include software by itself.

Variations of the embodiments described herein may become apparent to those having ordinary skill in the art upon reading the foregoing description. Skilled artisans will employ such variations as appropriate, and aspects of this disclosure can be practiced other than as specifically described herein. Accordingly, the scope of this disclosure includes all modifications and equivalents of the subject matter recited in the claims appended hereto as permitted by applicable law. Moreover, any combination of the above-described elements in all possible variations hereof is encompassed by this disclosure unless otherwise indicated herein or otherwise clearly contradicted by context.

In FIGS. 2-6, a plurality of operations are illustrated and described, though it is not necessary each operation be performed, nor is it necessary the operations be performed in the illustrated order or serially.

While the disclosure above sets forth the principles, with the examples given for illustration only, one should realize the use of this disclosure includes all usual variations, adaptations and/or modifications within the scope of the claims attached as well as equivalents thereof.

All references, including publications, patent applications, and patents, cited herein are hereby incorporated by reference to the same extent as if each reference were individually and specifically indicated to be incorporated by reference and were set forth in its entirety herein.

The use of the terms “a,” “an,” “the,” and similar referents in the context of the disclosure and claims are to be construed to cover both the singular and the plural, unless otherwise indicated herein or clearly contradicted by context. The terms “comprising,” “having,” “including,” and “containing” are to be construed as open-ended terms (i.e., “including, but not limited to,”) unless otherwise noted. Recitation of ranges as values herein are merely intended to serve as a shorthand method of referring individually to each separate value falling within the range, unless otherwise indicated herein, and each separate value is incorporated into the specification as if it was individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure (i.e., “such as, but not limited to,”) unless otherwise claimed. No language in the specification should be construed as indicating any non-claimed element as essential.

Terms such as “one embodiment,” “another embodiment,” “some embodiments,” “alternative embodiment,” “one implementation,” “one example,” and the like are not intended to exclude combinations of the various embodiments or implementations. In addition, similarly named embodiments, implementations, or examples do not necessarily refer to a single embodiment requiring features of all so-named embodiments, implementations, or examples.

Those skilled in the art will appreciate from the foregoing that various adaptations and modifications of the just described embodiments can be configured without departing from the scope and spirit of the disclosure. Therefore, it is to be understood that, within the scope of the appended claims, embodiments may be practiced other than as specifically described herein.

1. A method, comprising: receiving a document indicating information and a charge; identifying a patient in response to a determination that a portion of the information matches a portion of information of a plurality of candidate patients; and determining an eligibility of the patient for a payor.

2. The method of claim 1, wherein the received information includes a first name or a last name of the patient, and the determination determines that a predetermined number of letters of the first name or the last name matches a predetermined number of letters of a first name or a last name of one of the plurality of candidate patients.

3. The method of claim 1, further comprising: determining if a predetermined number of letters of a first name or a last name of the patient matches a predetermined number of letters of a first name or a last name of one of the plurality of candidate patients and if a date associated with the patient matches a date associated with the one of the plurality of candidate patients.

4. The method of claim 1, further comprising: associating the information with an event based on a weighted determination of a medical record number, a provider name, a patient account number, and dates of service of one of the plurality of candidate patients.

5. The method of claim 1, further comprising: investigating the payor based on the information.

6. The method of claim 5, further comprising: billing at least a portion of the charge to the payor.

7. The method of claim 1, further comprising: generating a notification of a remaining balance in response to a determination that a last payor of a determined order has been reached.

8. An apparatus comprising: a processor circuit configured to receive a document indicating information and a charge, to identify a patient in response to a determination that a portion of the information matches a portion of information of a plurality of candidate patients, and to determine an eligibility of the patient for a payor.

9. The apparatus of claim 8, wherein the received information includes a first name or a last name of the patient, and the determination determines that a predetermined number of letters of the first name or the last name matches a predetermined number of letters of a first name or a last name of one of the plurality of candidate patients.

10. The apparatus of claim 8, wherein the processor circuit is further configured to determine if a predetermined number of letters of a first name or a last name of the patient matches a predetermined number of letters of a first name or a last name of one of the plurality of candidate patients and if a date associated with the patient matches a date associated with the one of the plurality of candidate patients.

11. The apparatus of claim 8, wherein the processor circuit is further configured to associate the information with an event based on a weighted determination of a medical record number, a provider name, a patient account number, and dates of service of one of the plurality of candidate patients.

12. The apparatus of claim 8, wherein the processor circuit is further configured to investigate the payor based on the information.

13. The apparatus of claim 12, wherein the processor circuit is further configured to bill at least a portion of the charge to the payor.

14. The apparatus of claim 8, wherein the processor circuit is further configured to generate a notification of a remaining balance in response to a determination that a last payor of a determined order has been reached.

15. A non-transitory, computer-readable medium encoded with computer-executable instructions that, when executed by a processing unit, cause the processing unit to perform a method comprising: receiving a document indicating information and a charge; identifying a patient in response to a determination that a portion of the information matches a portion of information of a plurality of candidate patients; and determining an eligibility of the patient for a payor.

16. The medium of claim 15, wherein the received information includes a first name or a last name of the patient, and the determination determines that a predetermined number of letters of the first name or the last name matches a predetermined number of letters of a first name or a last name of one of the plurality of candidate patients.

17. The medium of claim 15, the method further comprising: determining if a predetermined number of letters of a first name or a last name of the patient matches a predetermined number of letters of a first name or a last name of one of the plurality of candidate patients and if a date associated with the patient matches a date associated with the one of the plurality of candidate patients.

18. The medium of claim 15, the method further comprising: associating the information with an event based on a weighted determination of a medical record number, a provider name, a patient account number, and dates of service of one of the plurality of candidate patients.

19. The medium of claim 15, the method further comprising: investigating the payor based on the information; and billing at least a portion of the charge to the payor.

20. The medium of claim 15, the method further comprising: generating a notification of a remaining balance in response to a determination that a last payor of a determined order has been reached.
